(19) United States
(12) Patent Application Publication
(10) Pub. No.: US 2008/0240435 A1
(43) Pub. Date: Oct. 2, 2008

(54) Perpetual Masking For Secure Watermark Embedding

(76) Inventors: Mehmet Utku Celik, Eindhoven (NL); Aweke Negash Lemma, Eindhoven (NL); Minne Van Der Veen, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 12/093,690

(22) PCT Filed: Nov. 6, 2006
(86) PCT No.: PCT/IB06/54117

§ 371 Date: May 14, 2008

(30) Foreign Application Priority Data
Nov. 17, 2005 (EP) 05110845.4

(51) Int. Cl. H04L 9/00

(52) U.S. Cl. 380/255

(57) ABSTRACT

Disclosed are a method and a system for secure watermark embedding in a server-client configuration (60,70). The method comprises encrypting (210) the data signal (x) and generating (240) a decryption key wherein a watermark (Wᵢ) is included. The client decrypts (420) the encrypted data signal in order to obtain a watermarked data signal (x_{w}). In accordance with the invention, the encryption mechanism and decryption key are made dependent on a perceptual mask (m₁,m₂) so as eventually make the embedded watermark more robust.

### FIELD OF THE INVENTION

The present invention relates to secure watermark embedding methods; in particular, but not exclusively, the invention relates to a secure watermark embedding method that uses perceptual masking to improve the robustness of the embedded watermark. The invention further relates to systems for secure watermark embedding using perceptual masking. Moreover the invention relates to software for implementing the method.

### BACKGROUND OF THE INVENTION

Digital watermarking has been proven as one of the most effective deterrents against illegal distribution of copyrighted material in digital form over computer networks, electronic content distribution (ECD) applications or hand-to-hand public distribution.

Watermarking is implemented generally by a pre-coding stage where a watermark is generated and an embedding stage where the watermark is added to the original digital object. A watermark detector extracts the watermark from the watermarked digital object allowing copyright identification.

Perceptual masking refers to local and/or global adjustments to the watermark strength in accordance with the human audio-visual perception. Exploiting the human perception characteristics it is possible to embed a stronger watermark signal to the digital content, thus improving the robustness against malicious attacks, without any adverse effects on the perceptual quality of the watermarked digital object. The process of perceptual masking typically involves multiplying the watermark with a mask computed from the digital content in advance of the actual watermark embedding process.

Perceptual masks are used in audio and video watermarking. For example the basic perceptual model used in MP3, MP3 stands for MPEG 1 (Motion Picture Experts Group) Layer 3, is that louder frequencies mask out adjacent quieter ones. People cannot hear a quiet sound at one frequency if there is a loud sound at another frequency. Spatial perceptual masks in video signals or images can be based for example on the fact that an edge in an image raises the perceptual threshold around it. The masking model can provide a prediction which ensures that changes below a calculate threshold will introduce no perceptible distortion.

A prior art method for secure video broadcasting or multicasting of watermarked digital content within a server-client architecture has been described in the article by Sabu Enmanuel et al. “Copyright protection for MPEG-2 compressed broadcast video”, IEEE International Conference on Multimedia and Expo 2001, pages 273-276. The method allows sending digital content and a watermark to a client or a group of clients in a way that the original content and the watermark are not accessible directly by the client. The client can only access a corrupted digital copy and an encrypted watermark, and needs to combine both in order to access the digital content in which a watermark has been embedded.

### SUMMARY OF THE INVENTION

The prior art method does not refer to the possibility of including a perceptual mask in the embedding process of the watermark neither to a method of using a perceptual mask in order to provide a robust method for secure server-client watermark embedding.

The inventor of the present invention has appreciated that an improved method for server-client watermark embedding including perceptual masking will be advantageous, as it will improve the robustness and perceptual quality of the watermark. Furthermore a method for watermark embedding where the perceptual mask is applied to the watermark at the embedder will be advantageous. A method for server-client watermark embedding that can be used in a live distribution event within a multicast transmission protocol will also be advantageous.

The present invention seeks to provide an improved method and a system that enables secure watermark embedding including perceptual masking in the watermark embedding process. It is further an object of the invention to provide a method and a system for secure watermark embedding using perceptual masking, that is secure in the exchange of information between a client and a server and that is cost and computational effective. Preferably, the invention alleviates, mitigates or eliminates one or more of the above or other disadvantages singly or in any combination.

Accordingly there is provided, in a first aspect, a method for embedding a watermark in a data signal, comprising the steps of

encrypting the data signal in a way that the encryption mechanism is at least partially dependent on a first perceptual mask and an encryption key.

generating a decryption key wherein a watermark is included.

decrypting the encrypted data signal in order to obtain a watermarked data signal where the decryption mechanism is at least partially dependent on a second perceptual mask and said decryption key.

In the watermark embedding method the encryption of the data signal and the generation of a decryption key may be performed at a trusted computing system, trusted by the owner of the content of the data signal and the owner of the watermark. On the other hand the decryption of the encrypted data signal may be performed at an untrusted computing system without exposure at any time of the data signal or the watermark in an unencrypted form. Other possible implementations of the method could involve all steps of the method being performed at the same computer system wherein the encryption of the data signal and the generation of a decryption key may be performed by a trusted user of the computer system while the decryption of the encrypted data signal may be performed by an untrusted user.

In the watermark embedding method, the watermark can refer to any kind of information embedded or omitted within a digital object, watermarks, fingerprints or equivalent entities such as entities lacking, omitting or changing specific data or information within the digital object with purposes such as copyright protection, e.g. controlled changes in the least significant bits of specific segments or parts of the digital object will also be considered as a watermark. The data signal consists in an amount of organized digital data being temporarily or permanently stored in a hard disk, diskette, DVD, CD-ROM, USB-Key or any other similar read-only or read-and-write memory elements. The first perceptual mask and the second perceptual may be the same perceptual mask or different perceptual masks. The perceptual masks may consist in an amount of organized digital data that may be related to the data signal and may exploiting the human audio-visual perception in relation to the data signal. Perceptual masks could be based on a specific filtering function related to the frequency content of the data signal, edge detection algorithms applied to image based data signals or in any other relation exploiting the human audio-visual perception. The perceptual masks may be independent of the content of the data signal.

The invention is particularly advantageous for a number of reasons. An important advantage is that the watermark is embedded to the data signal in a way that protects the data signal and the watermark to untrusted entities without revealing their content. Simultaneously the watermark embedding process applies a perceptual mask to the watermark without exposure of the content of the watermark to an untrusted entity. Moreover, since the watermark is embedded in the data signal based on a perceptual mask it will improve the robustness and perceptual quality of the watermark.

The optional features as defined in claim 2 are advantageous since the perceptual masks will be independent of the contents of the data signal and therefore the processing requirements will be reduced accordingly. The perceptual mask may consist of a high pass filtered version of the watermark signal, wherein the high pass filter may be related to the inverse of the human visual sensitivity.

The optional feature defined in claim 3 are advantageous since it allows for an effective perceptual mask watermark embedding process without the need for transferring the first perceptual mask used for the encryption of the data signal to the decryption entity of the embedding process. The first perceptual mask applied for example to an image data signal could be related for each pixel of the image to the luminescence value of the neighbouring pixels of the said pixel of the image. The second perceptual mask can then be extracted accordingly from the encrypted content of the data signal.

The optional features defined in claim 4 are advantageous since they allow storing the results of the data signal encryption and the perceptual mask in a data carrier that can be later accessed by the decryption entity of the embedding process. This feature furthermore ensures the possible reuse of the results obtain from the data signal encryption and perceptual mask generation which will reduce the processing requirements in the case the same data signal has to be embedded of a particular watermark in several independent decryption entities.

The optional features defined in claim 5 are advantageous since they allow for the method to be used in a client-server architecture and ensure that the first and second perceptual mask are the same and that the perceptual mask is transferred from the server to the client. This feature ensures that a best effort perceptual mask may be applied at the client side ensuring the best perceptual masking of the watermark in the embedding process.

The optional features defined in claim 6 are advantageous since the risk for a malicious user to have access to the content of the data signal, the watermark or the perceptual mask related to the content of the data signal is reduced by sending the perceptual mask, the encrypted content of the data signal and/or the decryption key from the server computing system to the client computing system via separate communication channels.

The optional features defined in claim 7 are advantageous since by sending the perceptual mask, the encrypted content of the data signal and/or the decryption key from the server computing system to the client computing system via the same communication channels the transferring process is simplified and the probability of erroneous transmission reduced.

The optional features defined in claim 8 disclose an advantageous implementation of the encryption mechanism partially dependent on a first perceptual mask and the decryption mechanism partially dependent on a second perceptual mask. The advantageous implementation involves the use of a first auxiliary key derived from the encryption key in the encryption mechanism and the use of a second auxiliary key derived from the decryption key in the decryption mechanism. Furthermore the advantageous implementation involves applying a perceptual mask to the first auxiliary key in the encryption process and applying a perceptual mask to the second auxiliary key in the decryption process. The main advantage of this particular implementation being that it enhances the security of the method.

The optional features defined in claim 9 to 11 disclose alternative embodiments according to the way the perceptual mask is applied to an auxiliary key. In claim 9 the embodiment involves multiplication elements of the encryption key, the decryption key and/or the auxiliary key with elements of a perceptual mask. In claim 10 the embodiment involves filtering elements of the encryption key, the decryption key and/or the auxiliary key with elements of a perceptually relevant filter. In claim 11 the embodiment involves encryption of the data signal using a first encryption key, encryption of the watermark signal using a second encryption key providing an encrypted watermark, where encrypted watermark becomes a decryption key necessary to decrypt the encrypted data signal, using the homomorphism of the encryption mechanism to apply a perceptual mask to the decryption key providing a perceptually masked decryption key and decrypting the data signal using the perceptually masked decryption key therefore obtaining the decrypted content of the watermarked data signal.

The optional features as defined in claim 12 are advantageous since by providing multiple decryption keys that include different watermarks may be used for example in a situation were the same data signal should be accessed by different users for which different watermarks are intended.

The optional features as defined in claim 13 disclose advantageous embodiments according to the possible content of the data signal. The data signal may comprise at least one of: audio, video, images, multimedia software, multidimensional graphical models, software structures.

The optional features as defined in claim 14 are advantageous since they present additional steps required for the method for embedding a watermark of claim 1 to be alternatively used in the transmission of a live event from a server computing system to a plurality of client computing systems in a secure and effective way.

The optional features defined in claim 15 disclose additional advantageous steps of the method for embedding a watermark being used in the transmission of a live event wherein two or more different decryption keys corresponding to one encryption key and include different watermarks are generated a the server computing system and transmitted to the client computing system prior to the start of the live event. These additional steps ensure that the clients interested in the live event have received the required decryption keys prior to the transmission of the live event. Furthermore these additional steps may allow providing individual watermarks to specific clients or if necessary an individual watermark for each client of the live event transmission.

In a second aspect of the invention there is provided a method for embedding a watermark in a data signal comprising the steps of:
encrypting the data signal in a way that the encryption mechanism is at least-partially dependent on a first perceptual mask and an encryption key.
generating a decryption key wherein a watermark is included.

This second aspect of the invention is particularly advantageous as it allows to generate elements required for a watermark embedding system independently of the decrypting entity.

In a third aspect of the invention there is provided a method for embedding a watermark in a data signal, comprising the step of

decrypting a encrypted data signal in order to obtain a watermarked data signal where the decryption mechanism is at least partially dependent on a second perceptual mask and a decryption key.

This third aspect of the invention is particularly advantageous as it allows decrypting an encrypted data signal providing a watermarked data signal independently of the encrypting entity.

In a fourth aspect of the invention there is provided a content distribution system wherein a server computing system is operable to:

encrypt the content of a data signal in a way that the encryption mechanism is at least partially dependent on a perceptual mask;

generate a decryption key wherein a watermark is included;

transmit the encrypted content of the data signal and the decryption key to a client computing system

In a fifth aspect of the invention there is provided a computing system for watermark embedding being operable to:

receive an encrypted data signal and an decryption key from a computing system; and

decrypt the encrypted data signal in order to obtain a watermarked data signal wherein the decryption mechanism is at least partially dependent on a perceptual mask and said decryption key.

In a sixth aspect of the invention there is provided a live event distribution system comprising

a server computing system

two more client computing system

wherein the distribution of one or more data signals from the server computing system to two or more client computing systems constitute the live event, wherein

two or more different decryption keys, which correspond to one encryption key and include different watermarks, are generated at the server computing system;

each decryption key is transmitted to a client computing system prior to the start of the live event;

a perceptual mask is computed from the content of the data signals and at least partially used for encrypting the content of the data signals; and

the encrypted content of the data signals and the corresponding perceptual mask are sent to the client computing systems.

In a seventh aspect of the invention there is provided a computer readable code for implementing the method of the first aspect.

In general the various aspects of the invention may be combined and coupled in any way possible within the scope of the invention.

These and other aspects, features and/or advantages of the invention will be apparent from and elucidated with reference to the embodiments described hereinafter.

### DESCRIPTION OF THE DIAGRAMS

The present invention will now be explained, by the way of example only, with reference to the accompanying Figures wherein:

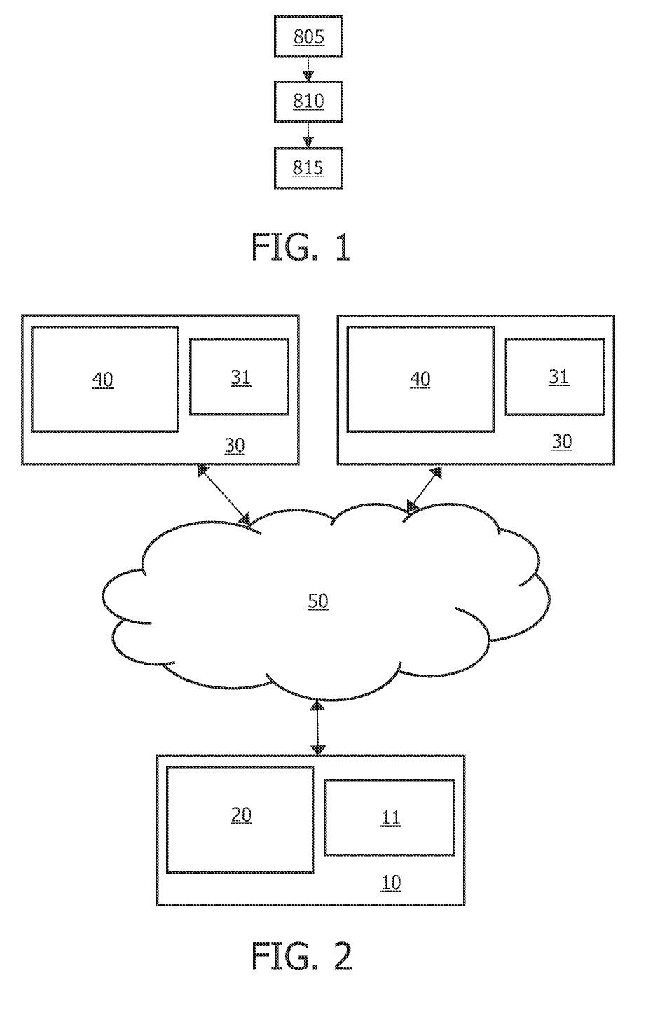

FIG. 1 is a flow chart illustrating a method of secure watermark embedding using perceptual masking;

FIG. 2 is a representation of a server-client architecture for distribution of digital content with secure watermark embedding;

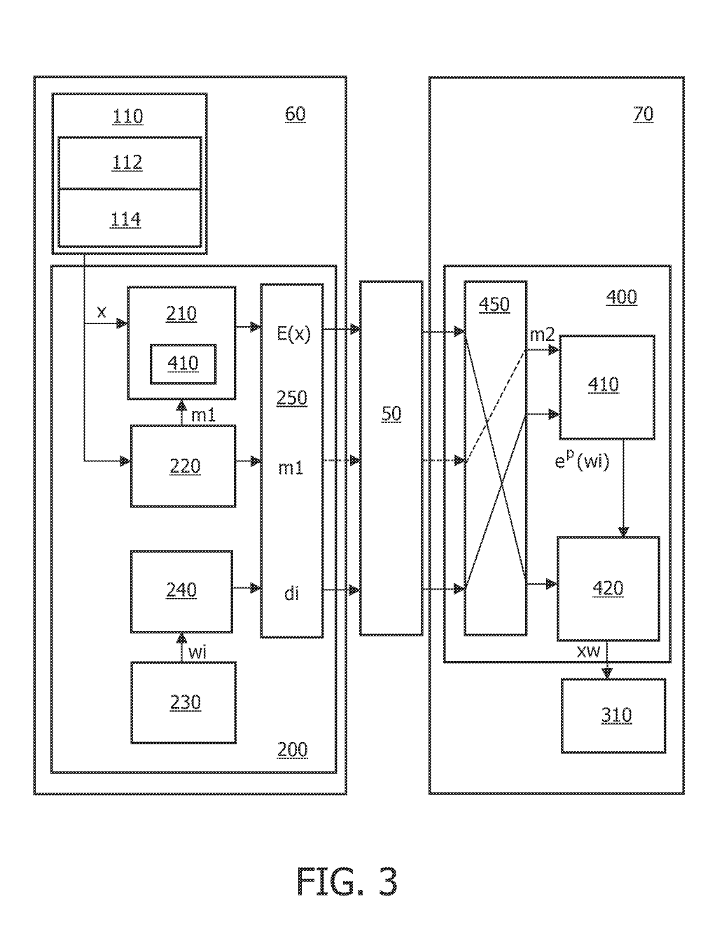

FIG. 3 is a block diagram illustrating a system for secure watermark embedding using perceptual masking in a server-client configuration according to one embodiment of the invention;

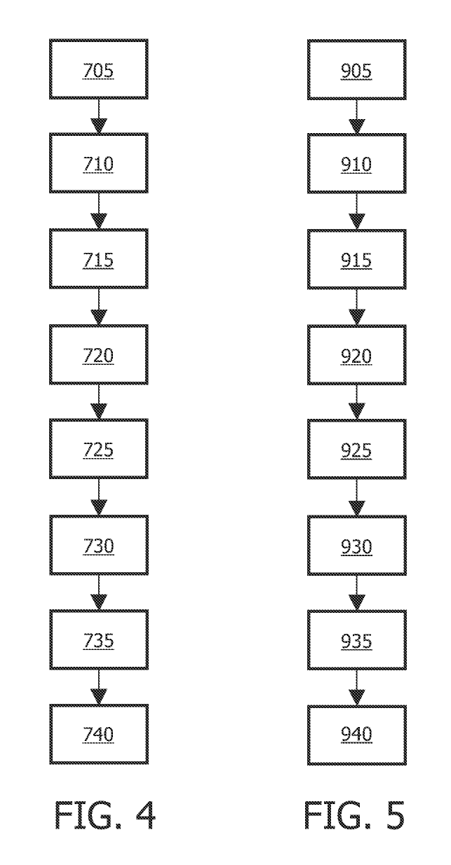

FIGS. 4 and 5 are flow charts illustrating methods of secure watermark embedding using perceptual masking by a server-client configuration according to different embodiments of the invention.

### DESCRIPTION OF EMBODIMENTS OF THE INVENTION

The present invention provides a method for embedding a watermark in a data signal that is based on encryption of a data signal and the decryption of the encrypted data signal by means of mechanisms that are at least partially dependent on perceptual masks. A flow chart presenting the main steps of the method for embedding a watermark in a data signal is shown in FIG. 1. In step 805 the data signal is encrypted in a way that the encrypted mechanism is at least partially dependent on a first perceptual mask and an encryption key. In 810 a decryption key is generated wherein a watermark is included. In the final step 815 the encrypted data signal is decrypted in order to obtain a watermarked data signal, the encryption mechanism used in this step is at least partially dependent on a second perceptual mask and the decryption key generated in 810. The first perceptual mask and the encryption key may be generated at the same or a different computer system that encrypts the data signal. The generation of the decryption key may be performed at the same or at a different computer system than the one encrypting the data signal. The decryption of the encrypted data signal may be performed at the same or at different computer systems than those used in the encryption of the data signal or the generation of the decryption key, however a certain level of security has to be ensured within the decryption step, ensuring that the computer system or the user of the computer system has never direct access to the original data signal and/or the watermark signal.

In one embodiment of the invention all the steps of the method shown in FIG. 1 are implemented within the same computer system, however different users are entitled to implement the different steps of the method according to the degree of trust provided by the owner of the content of the data signal or its distributor. For example a user with an special level of trust, a super-user or an administrator of the system, might be allowed to access the data signal, encrypt the data signal following step 805 and generate a decryption key according to step 810. A general user of the same computer system will only be allowed to access the encrypted data signal, the decryption key and a second perceptual mask in order to decrypt the data signal and obtain a watermarked data signal.

Different embodiments of the invention can be implemented according to the nature of the first and second perceptual masks. In one embodiment of the invention the first perceptual mask and second perceptual mask are independent of the contents of the data signal. The first and second perceptual mask may be equal to each other or may be different to each other. In another embodiment of the invention the first perceptual mask may be related to the content of the data signal and the second perceptual mask may be extracted from the encrypted content of the data signal.

In another embodiment of the invention the encryption of the data signal is performed in a server computing system while the decryption of the encrypted data signal is performed in a client computing system. The second perceptual mask is equal to the first perceptual mask as it is actually a copy of the first perceptual mask being transmitted from the server computing system to the client computing system.

Distribution of digital content occurs within the interaction between the owner or distributor of the digital content, server, and the user interested in receiving a copy of the digital content, client, wherein server and client communicate within a computer network, i.e. the Internet. Large-scale deployment of forensic tracking watermarks requires an efficient and scalable system for embedding watermarks and distributing watermarked digital contents. In order to reduce server's processing load, part of the watermark processing required can be performed at the client's side. However client-side embedding has one major drawback, the client cannot be trusted to embed the watermark on the correct digital content. Therefore the client should never have access to the original digital content nor the original watermark.

An illustrative representation of a typical server-client architecture for distribution of digital content with secure watermark embedding is shown in FIG. 2. It consists of a server 10, a series of clients 30 and computer network 50 that allows communication between the server 10 and the clients 30. The server comprises among other components of a server-side watermark embedder 20 and a server database 11. The client comprises among other components of a client-side watermark embedder 40 and a client database 31. Server and clients can comprise other elements or components, e.g. processors, memories or a user interface.

The secure watermark embedding mechanism is typically initiated by a petition from the client 30 to the server 10 for access to, and/or download of, a specific digital content. The server will typically check the client's status in terms of its rights to access/download the specific digital content. If the client is accepted for the access/download a copy of the original digital content stored in the database 11 will be provided to the server-side watermark embedder 20, where the digital content and a generated watermark are pre-processed to ensure that they are not directly visible at the client. At the client 30, the client-side watermark embedder 40 combines the pre-processed digital content and pre-processed watermark in a way that the watermark is embedded in the digital content. Finally the watermarked digital content can be stored at the clients database 31.

A block diagram illustrating a system for secure watermark embedding using perceptual masking in a server-client configuration is shown in FIG. 3 according to one embodiment of the invention. The system comprising a server 60, a client 70 and a computer network, 50. The server 60 comprises a server-side watermark embedder 200 and a server database 110. The server-side watermark embedder 200 comprises a watermark generator 230, an encryption device 210, a perceptual mask generator 220, a decryption key generator 240 and a server network interface 250. The encryption device 210 contains among other components a perceptual mask applicator 410. The server database 110 comprises digital content for distribution 114 and other digital content 112. The client 70 comprises a client-side watermark embedder 400 and a client database 310. The client-side watermark embedder 400 comprises a perceptual mask applicator 410, a decryptor 420 and a client network interface 450.

The method of secure watermark embedding using perceptual masking as performed by this sever-client configuration will now be described.

The client 70 requires from the server 60 a specific digital object x. The server extracts from the database 110 a copy of the digital content x, and provides it to the first encryption device 210. The perceptual mask generator 220 generates a first perceptual mask m₁, preferably also based on the contents of the digital object. Encryption device 210 encrypts the digital content in such a way that the perceptual mask m₁ influences the encryption, thus providing an encrypted digital object e (x). The server also generates a watermark wᵢ, which is specific for the client i, and provides a decryption key dᵢ which also conveys said waterwark. The server 60 then sends the encrypted digital object e(x), the decryption key dᵢ, and (optionally) the perceptual mask m₁, to the client via the network 50.

The encrypted digital object, decryption key, and perceptual mask are received by the client 70. The perceptual mask applicator 410 in client 70 applies the perceptual mask m₁ to the decryption key dᵢ, thereby providing a perceptually masked decryption key e^{p}(wᵢ). If the first perceptual mask m₁ was not transmitted by the server, a predetermined second perceptual mask m₂ may be used. The application of the perceptual mask to the decryption key is done in such a way that using the perceptually masked decryption key e^{p}(wᵢ) to decrypt the encrypted digital object e(x) in decryptor provides directly the envisioned watermarked digital content for the client x_{w}.

The server can store the perceptual mask, the encrypted digital object and/or the decryption key in a data carrier, e.g. a DVD, floppy disk, USB key, Hard disk or any other memory capable element. The client might access the data carrier and extract the perceptual mask, the encrypted digital object and/or the decryption key in order to proceed with the watermark embedding process.

The invention allows different clients to access the same data signal while the server only generates different watermarks and accordingly different decryption keys for the clients.

In one embodiment of the invention, the encryption of a digital image x is implemented as depicted in equation (1) by adding to the original image an encrypting mask obtained from the multiplication of an opaque mask, r, by the perceptual mask, m, which results in combined encrypted image, e(x). In the referred embodiment the decryption key, e(wᵢ), is generated by subtraction of the opaque mask, r, from the watermark, wᵢ, as shown in equation (2).

e(x)=x+m·r (1)

e(wᵢ)=wᵢ−r (2)

In the referred embodiment the application of the perceptual mask to the decryption key consists of multiplying the decryption key by the perceptual mask as depicted in equation (3) providing the perceptually masked decryption key, e^{p}(wᵢ). Finally combining e(x) with e^{p}(wᵢ) by addition as in equation (4) provides the perceptually masked watermarked digital object, x_{w}.

e^{p}(wᵢ)=m·e(wᵢ)=m·wᵢ−m·r (3)

x_{w}=e(x)+e^{p}(wᵢ)=x+m·wᵢ (4)

In another embodiment of the invention the application of the perceptual mask to the encryption of the content and to the decryption key at the perceptual mask applicators 410 involves applying a linear filter, h(·), to the content of the encryption and to the decryption key respectively. In the example of a digital image described above, the encryption of a digital image, x, is implemented as depicted in equation (5) by adding to the original image an encrypting mask obtained from the filtering of an opaque mask, r, by the perceptual mask filter, h(·), which results in combined encrypted image, e^{f}(x). The application of the perceptual mask filter to the decryption key at the client provides a perceptually masked decryption key, e^{pf}(wᵢ) as depicted in equation (6) by using the linear property of the filter. Finally combining e^{f}(x) with e^{p}(wᵢ) by addition at the decryptor 420 following equation (7) provides the perceptually masked watermarked digital object, x_{w}.

e^{f}(x)=x+h(r) (5)

e^{pf}(wᵢ)=h(wᵢ−r)=h(wᵢ)−h(r) (6)

x_{w}=e^{f}(x)+e^{pf}(wᵢ)=x+h(wᵢ) (7)

It is worth mentioning that where linearity is a required property of the filter, time-invariance is not and the filter may be changing over time.

The application of the perceptual mask by means of multiplication, by m in the example above, can be considered as a special case of a linear filter where the impulse response of the filter is m·δ(t).

Different embodiments of the invention can be considered according to the way the perceptual mask, the encrypted content of the digital carrying signal and the decryption key are sent from the server to the client. In one embodiment all three elements are sent from the server to the client via the same communication connection established within the computer network. In another embodiment the elements might be sent via two or three separate independent communication connections within the computer network ensuring that no malicious intermediate user of the network has access to all the elements simultaneously reducing the possibility of fraud in the watermark embedding process.

Different embodiments of the invention can also be considered according to the conditions required to be fulfilled by the client in order to access the server. In one embodiment of the invention the perceptual mask and the encrypted content of the digital carrying signal are sent to the client upon establishment of a connection within the computer network while the decryption key is send to the client only after a formal petition by the client and security check by the server.

A flow chart presenting steps of another possible embodiment of the invention describing secure watermark embedding using perceptual masking within a sever-client configuration is presented in FIG. 4. The embodiment is based on the use of an El Gamal cipher as basis for the encryption mechanism. El Gamal encryption involves exponentiation of base g and modular arithmetic in p; where p is a suitably chosen large prime and g is chosen to satisfy equation (11) in modulo p arithmetic.

g^{P-1}=1 (11)

All the steps presented in the following description of this specific embodiment are performed in modular arithmetic in p. In step 705 a data signal, x, is encrypted at the server into two parts. The first part, g^{m}*^{r}, is obtained by exponentiation of base g, using the perceptual mask “m” and random values of “r”. The second part being obtained by exponentiation of base g, using a first encryption key k1, the perceptual mask m and random values, r, providing an encrypted data signal, e(x), following equation (12)

e(x)=g^{x}·g^{r·m·k1} (12)

In step 710 the server generates a watermark, wᵢ, specific for the client and related to the digital content to be distributed. The watermark is generated and encrypted using a second encryption key, k2, and exponentiation of base g following equation (13), providing an encrypted watermark, e(wᵢ), that can be used as a decryption key.

e(wᵢ)=g^{w}^{ᵢ}·g^{r·k2} (13)

In step 715 a third key, k3, is generated in a way that it is directly related to k1 and k2. For example k3 might be the direct sum of k1 and k2. In step 720 k3, the perceptual mask, m, the decryption key, e(wᵢ), and the two parts of the encrypted data, e(x) and g^{m}*, are sent from the server to the client. The client will have access to k3 but direct access to k1 or k2 is avoided ensuring inability of the client to access the original data signal or the watermark directly. In step 725 the perceptual mask is applied to the decryption key at the client using the homomorphism property of the encryption method based on El Gammal cipher following equation (14) and providing a perceptually masked decryption key, e^{p}(wᵢ). The homomorphism property allows performing operations on the underlying quantities by manipulating their encrypted versions, without decrypting them.

e^{p}(wᵢ)=[e(wᵢ)]^{m}=g^{w·m}·g^{r·k2·m} (14)

In step 730 the encrypted data signal, e(x), is combined with the perceptually masked watermark, e^{p}(wᵢ), as first sub-step of the decryption process following equation (15) and providing a combination signal, Com.

Com=e(x)·e^{p}(wᵢ)=g^{x+w·m}·g^{r·m·(k1+k2)} (15)

Step 735 describes a second sub-step of the decryption process, the third key k3 is applied to the second part of the encrypted data g^{m}*^{r} and the result is inverted providing g^{-r}*^{m}*^{k3}, which is further applied to the combination signal, Com, following equation (16), providing the watermarked data signal in exponentiation of base g, g^{x+w}*^{m}.

x_{w}=Com·g^{-r·m·k3}=Com·g^{-r·m·(k1+k2)}=g^{x+w·m} (16)

Finally in Step 740 the watermarked data signal. x_{w}, may be then recovered by access to a look-up-table, which is related to the base g and functions as the discrete logarithm.

Efficiency and scalability of forensic tracking watermarks is particularly important for live event distribution, where watermark embedding and content distribution should take place in real-time with minimum-delay. In live event watermarking, it is desirable to offload any real-time per-client processing either to the client-side or to an offline process. In one embodiment of the invention the perceptually masked watermark embedding processed is optimised for the distribution of a live event containing a series of digital contents from a server to a series of clients. The steps of the optimised process can be observed in FIG. 5. The clients that are interested in receiving the live event from the server contact the server 905 in order to provide a list of clients to which the live event is to be sent to. The server in step 910 generates a unique watermark for each of the clients that will be receiving the live event, generates a decryption key for each client including its specific watermark 915 and sends the decryption key 920 to the specific client. These steps of the process could be performed well in advance of the actual occurrence of the live event. When the live event starts a perceptual mask is generated in synchronism 925 to obtaining at the server the digital content from the live event. As the digital content is obtained at the server it is directly encrypted in a way that the encryption mechanism is at least partially dependent on the perceptual mask and sent together with the perceptual mask to all the clients in a multicast or broadcast communication 930, e.g. using the Internet Group Management Protocol (IGMP). Each client applies the perceptual mask to the received decryption key 935 and decrypts the encrypted content using the perceptually masked decryption key 940 obtaining the watermarked content of the live event.

In an alternative implementation of the referred embodiment different watermarks are generated for specific types of clients to be receiving the contents of the live event. Therefore different clients that might share certain common characteristics, e.g. being part of the same corporation that has bought rights to access the contents of the live event, may share a decryption key.

The invention can be implemented in any suitable form including hardware, software, firmware or any combination of these. The invention can be implemented as computer software running on one or more data processors and/or digital signal processors. The elements and components of an embodiment of the invention may be physically, functionally and logically implemented in any suitable way. Indeed, the functionality may be implemented in a single unit, in a plurality of units or as part of other functional units. As such, the invention may be implemented in a single unit, or may be physically and functionally distributed between different units and processors.

Although the present invention has been described in connection with preferred embodiments, it is not intended to be limited to the specific form set forth herein. Rather, the scope of the present invention is limited only by the accompanying claims.

Disclosed are a method and a system for secure watermark embedding in a server-client configuration (60,70). The method comprises encrypting (210) the data signal (x) and generating (240) a decryption key wherein a watermark (wᵢ) is included. The client decrypts (420) the encrypted data signal in order to obtain a watermarked data signal (x_{w}). In accordance with the invention, the encryption mechanism and decryption key are made dependent on a perceptual mask (m₁,m₂) so as eventually make the embedded watermark more robust.

Specific details of the disclosed embodiments are set forth for purposes of explanation rather than limitation, so as to provide a clear and thorough understanding of the present invention. However, it should be understood readily by those skilled in this art, that the present invention may be practised in other embodiments which do not conform exactly to the details set forth herein, without departing significantly from the spirit and scope of this disclosure. Further, in this context, and for the purposes of brevity and clarity, detailed descriptions of well-known apparatus, circuits and methodology have been omitted so as to avoid unnecessary detail and possible confusion.

Reference signs are included in the claims, however the inclusion of the reference signs is only for clarity reasons and should not be construed as limiting the scope of the claims.

1. A method for embedding a watermark in a data signal, comprising the steps of
encrypting the data signal (805) in a way that the encryption mechanism is at least partially dependent on a first perceptual mask and an encryption key.
generating a decryption key (810) wherein a watermark is included.
decrypting the encrypted data signal (815) in order to obtain a watermarked data signal where the decryption mechanism is at least partially dependent on a second perceptual mask and said decryption key.

2. A method according to claim 1, wherein the first perceptual mask and second perceptual mask are independent of the contents of the data signal.

3. A method according to claim 1, wherein the first perceptual mask is related to the content of the data signal and/or the second perceptual mask can be extracted from the encrypted content of the data signal.

4. The method according to claim 1, wherein the encrypted data signal and the first perceptual mask reside at a data carrier prior to the step c of claim 1.

5. A method according to claim 1, wherein
the encryption of the data signal is performed in a server computing system (70);
the decryption of the encrypted data signal is performed in a client computing system (60); and
the second perceptual mask is equal to the first perceptual mask and the first perceptual mask is transferred from the server computing system to the client computing system.

6. The method according to claim 5, wherein the first perceptual mask, the encrypted content of the data signal and/or the decryption key are transferred from the server computing system to the client computing system (535) via separate communication channels.

7. The method according to claim 5, wherein the first perceptual mask, the encrypted content of the data signal and/or the decryption key are transferred from the server computing system to the client computing system (535) via the same communication channel.

8. The method according to claim 1, wherein the encryption of the data signal consists of:
deriving a first auxiliary key from the encryption key;
applying a perceptual mask to the first auxiliary key; and
encrypting the data signal using the resulting perceptually shaped first auxiliary key,
and/or wherein the decryption of the encrypted data signal consists of:
deriving a second auxiliary key from the decryption key;
applying a perceptual mask to the second auxiliary key; and
decrypting the encrypted data signal using the resulting perceptually shaped second auxiliary key.

9. The method according to claim 8, wherein applying a perceptual mask involves multiplying the elements of the encryption key, the decryption key and/or the auxiliary key with elements of the perceptual mask.

10. The method according to claim 8, wherein applying a perceptual mask involves filtering the elements of the encryption key, the decryption key and/or the auxiliary key with a perceptually relevant filter.

11. The method according to claim 8 wherein:
the data signal is encrypted using a first encryption key, k1;
the watermark signal is encrypted using a second encryption key (710), k2, providing an encrypted watermark;
the encrypted watermark can be used as a decryption key,
the homomorphism of the encryption mechanism is used for applying a perceptual mask to the decryption key (725), providing a perceptually masked decryption key; and
the encrypted data signal is decrypted (730,735) using the perceptually masked decryption key and a third key, k3, obtaining the decrypted content of the watermarked data signal.

12. The method according to claim 1, wherein multiple decryption keys that include different watermarks are generated.

13. The method of claim 1 wherein the data signal contains audio, video, images, multimedia software, multidimensional graphical models, software structures or a combination in any way of them.

14. The method of claim 1 being used in the transmission of a live event from a server computing system to a plurality of client computing systems and wherein
the encryption of the data signal is performed in a server computing system;
the decryption of the encrypted data signal is performed at the client computing systems;
the second perceptual mask is equal to the first perceptual mask and is transmitted from the server computing system to the client computing systems; and
the transmission of the encrypted content and/or the first perceptual mask is performed by means of a broadcast or multi-cast communication (930).

15. The method according to claim 14 wherein:
two or more different decryption keys, which correspond to one encryption key and include different watermarks, are generated at the server computing system;
the decryption keys are transmitted to a client computing system prior to the start of the live event (920);

16. A method for embedding a watermark in a data signal, comprising the steps of
encrypting the data signal in a way that the encryption mechanism is at least partially dependent on a first perceptual mask and an encryption key.
generating a decryption key wherein a watermark is included.

17. A method for embedding a watermark in a data signal, comprising the step of
decrypting a encrypted data signal in order to obtain a watermarked data signal where the decryption mechanism is at least partially dependent on a second perceptual mask and a decryption key.

18. A content distribution system wherein a server computing system is operable to:
encrypt the content of a data signal in a way that the encryption mechanism is at least partially dependent on a perceptual mask;
generate a decryption key wherein a watermark is included;
transmit the encrypted content of the data signal and the decryption key to a client computing system

19. A computing system for watermark embedding being operable to:
receive an encrypted data signal and an decryption key from a computing system; and
decrypt the encrypted data signal in order to obtain a watermarked data signal wherein the decryption mechanism is at least partially dependent on a perceptual mask and said decryption key.

20. A live event distribution system comprising
a server computing system
two more client computing system
wherein the distribution of one or more data signals from the server computing system to two or more client computing systems constitute the live event, wherein
two or more different decryption keys, which correspond to one encryption key and include different watermarks, are generated at the server computing system;
each decryption key is transmitted to a client computing system prior to the start of the live event;
a perceptual mask is computed from the content of the data signals and at least partially used for encrypting the content of the data signals; and
the encrypted content of the data signals and the corresponding perceptual mask are sent to the client computing systems.

21. A computer readable code for implementing the method of claim 1.
